(19) United States
(12) Patent Application Publication
(10) Pub. No.: US 2011/0154327 A1
(43) Pub. Date: Jun. 23, 2011

(54) METHOD AND APPARATUS FOR DATA CENTER AUTOMATION

(76) Inventors: Ulas C. Kozat, Santa Clara, CA (US); Rahul Urgaonkar, Los Angeles, CA (US)

(21) Appl. No.: 12/856,500

(22) Filed: Aug. 13, 2010

Related U.S. Application Data
(60) Provisional application No. 61/241,791, filed on Sep. 11, 2009.

(51) Int. Cl. G06F 9/455; G06F 15/173

(52) U.S. Cl. 718/1

(57) ABSTRACT

A method and apparatus is disclosed herein for data center automation. In one embodiment, a virtualized data center architecture comprises: a buffer to receive a plurality of requests from a plurality of applications; a plurality of physical servers, wherein each server of the plurality of servers having one or more server resources allocable to one or more virtual machines on said each server, wherein each virtual machine handles requests for a different one of a plurality of applications, and local resource managers each running on said each server to generate resource allocation decisions to allocate the one or more resources to the one or more virtual machines running on said each server; a router communicably coupled to the plurality of servers to control routing of each of the plurality of requests to an individual server in the plurality of servers; an admission controller to determine whether to admit the plurality of requests into the buffer, and a central resource manager to determine which server of the plurality of servers are active, wherein decisions of the central resource manager depends on backlog information per application at each of the plurality of servers and the router.

### PRIORITY

The present patent application claims priority to and incorporates by reference the corresponding provisional patent application Ser. No. 61/241,791, titled, “A Method and Apparatus for Data Center Automation with Backpressure Algorithms and Lyapunov Optimization,” filed on Sep. 11, 2009.

### FIELD OF THE INVENTION

The present invention relates to the field of data center, automation, virtualization, and stochastic control; more particularly, the present invention relates to data centers that use decoupled admission control, resource allocation and routing.

### BACKGROUND OF THE INVENTION

Datacenters provide computing facilities that can host multiple applications/services over the same physical servers. Some datacenters provide physical or virtual machines with fixed configurations including the CPU power, memory, and hard disk size. In some cases, such as, for example, Amazon's EC2 cloud, an option for selecting the rough geographical location is also given. In that modality, users of the datacenter (e.g., applications, service providers, enterprises, individual users, etc.) are responsible for estimating their demand and requesting/releasing additional/existing physical or virtual machines. Datacenters orthogonally determine their operational needs such as power management, rack management, fail-safe properties, etc. and execute them.

Many works exist that attempt to automate the resource allocation and management including scaling in and out decisions, power management, bandwidth provisioning in data centers by relying on the virtual machine technologies that separate the execution from the physical machine location and move resources around freely. Existing works on data automation however lack the rigor to show robustness against unpredictable load and do not decouple load balancing, power management, and admission control within the same optimization framework with configurable knobs.

### SUMMARY OF THE INVENTION

A method and apparatus is disclosed herein for data center automation. In one embodiment, a virtualized data center architecture comprisies: a buffer to receive a plurality of requests from a plurality of applications; a plurality of physical servers, wherein each server of the plurality of servers having one or more server resources allocable to one or more virtual machines on said each server, wherein each virtual machine handles requests for a different one of a plurality of applications, and local resource managers each running on said each server to generate resource allocation decisions to allocate the one or more resources to the one or more virtual machines running on said each server; a router communicably coupled to the plurality of servers to control routing of each of the plurality of requests to an individual server in the plurality of servers; an admission controller to determine whether to admit the plurality of requests into the buffer, and a central resource manager to determine which server of the plurality of servers are active, wherein decisions of the central resource manager depends on backlog information per application at each of the plurality of servers and the router.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a high level architecture for datacenter automation.

FIG. 2 illustrates an example block diagram that depicts the role of architectural components and signaling that exists between them in one embodiment of the present invention.

FIG. 3 is a block diagram of a computer system.

### DETAILED DESCRIPTION OF THE PRESENT INVENTION

A virtualized data center is disclosed that has multiple physical machines (e.g., servers) that host multiple applications. In one embodiment, each physical machine can serve a subset of the applications by providing a virtual machine for every application hosted on it. An application may have multiple instances running across different virtual machines in the data center. In general, applications may be multi-tiered and different tiers corresponding to an instance of an application may be located on different virtual machines that run over different physical machines. For purposes herein, the word “server” and “machine” are used interchangeably.

In one embodiment, the jobs for each application are first processed by an admission controller at the ingress of the data center that decides to admit or decline the job (i.e., a request). In one embodiment, the admission control decision in the distributed control algorithm is a simple threshold-based solution.

Once the jobs are admitted, they are buffered in routing/load balancing queues of their respective application. A load balancer/router decides which job of a particular application is to be forwarded to which virtual machine (VM) when there are more than one VM supporting the same application.

In one embodiment, each job is atomic, i.e., they can be processed independently at a given VM and rejection/decline of one job does not impact the other job. In web services, for instance, a job can be an http request. In distributed/parallel computing, a job can be a part of a larger computation of which the output does not depend on the other parts of the computation. In streaming, a job can be an initial session set-up request. Note that the jobs and data plane are orthogonal, e.g., in a video streaming session, job is the video request and once the session is established with a server, it is served from that server and subsequent message exchanges do not need to cross the admission controller or the load balancer.

In one embodiment, at each VM, a monitoring system keeps track of the service backlog on that VM (i.e., the number of unfinished jobs). In one embodiment, resource allocation decisions in the data center are handled by (i) a central entity that determines the physical server that needs to be active (with the rest of the servers being put in sleep/stand by/energy conserving modes) at a larger time scale by solving a global optimization problem and (ii) by individual physical servers in a shorter time scale (and locally, independent of other servers) via selection of the clock speed and voltage as a result of an optimization decision that tries to balance the job backlog at each VM and the power expenditure. When the central entity decides that some of the active machines can be turned off for power savings, the application jobs queued at those machines can be (i) frozen and served later when the server is back up again, (ii) rerouted to one of the VMs of the same application using the load balancer/router, (iii) moved to other physical machines by VM migration (hence more than one VM on the same physical machine can be serving the same application), and/or (iv) discarded by relying on the application layer to handle job losses. In one embodiment, when the central entity decides to activate more servers, the load balancers are informed about such a decision so that jobs waiting at the load balancer queues can be routed to these new locations. This potentially triggers a cloning operation for an application VM to be instantiated in the new location (if there is no such VM waiting in the dormant mode already).

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### System Model

In one embodiment, a virtualized data center has M servers that host a set of N applications. The set of servers is denoted herein by S and the set of applications is denoted herein by A. Each server jεS hosts a subset of the applications. It does so by providing a virtual machine for every application hosted on it. An application may have multiple instances running across different virtual machines in the data center. The following indicator variables are defined for iε{1, 2, . . . , N}, jε{1, 2, . . . , M}:
aᵢⱼ=1 if application i is hosted on server j; aᵢⱼ=0 otherwise.

For simplicity, in the following description, it is assumed that aᵢⱼ=1 for all i,j, i.e., each server can host all applications. This can be achieved, for example, by using methods like live virtual machine migration/cloning/replication, which are well known in the art. In general, applications may be multi-tiered and the different tiers corresponding to an instance of an application may be located on different servers and virtual machines. For simplicity, the case where each application consists of a single tier is described below.

While not required, in one embodiment, the data center operates as a time-slotted system as one embodiment. At every slot, new requests arrive for each application i according to a random arrival process Aᵢ(t) that has a time average rate λᵢ requests/slot. This process is assumed to be independent of the current amount of unfinished work in the system and has finite second moment. However, there is no assumption regarding any knowledge of the statistics of Aᵢ(t). In other words, the framework described herein does not rely on modeling and prediction of the workload at any time. For example, Aᵢ(t) could be a Markov-modulated process with time-varying instantaneous rates where the transition probabilities between different states are not known.

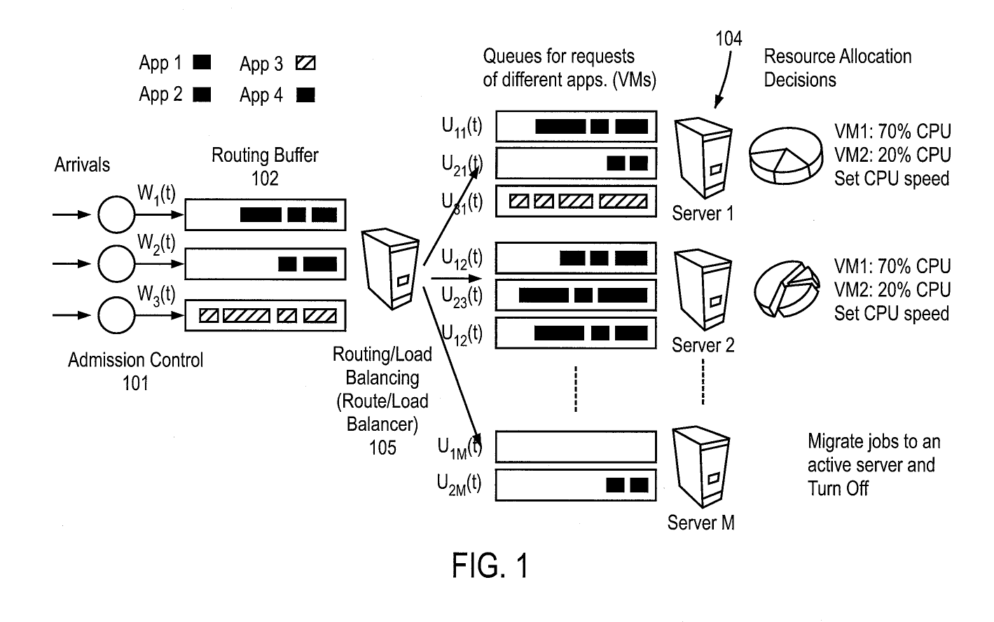

FIG. 1 illustrates one embodiment of a control architecture for a data center. Referring to FIG. 1, the control architecture consists of the three components. Referring to FIG. 1, arriving jobs are admitted or rejected by admission controller 101. If they are admitted, they are stored in routing buffer 102. From routing buffer 102, router 105 routes them to a specific one of servers 104_{1-M}. Router 105 may perform load balancing and thus act as a load balancer. Each of servers 104_{1-M} includes a queue for requests of different applications. In one embodiment, if one of servers 104_{1-M} has a VM to handle requests for a particular application, then the server includes a separate queue to store requests for that VM.

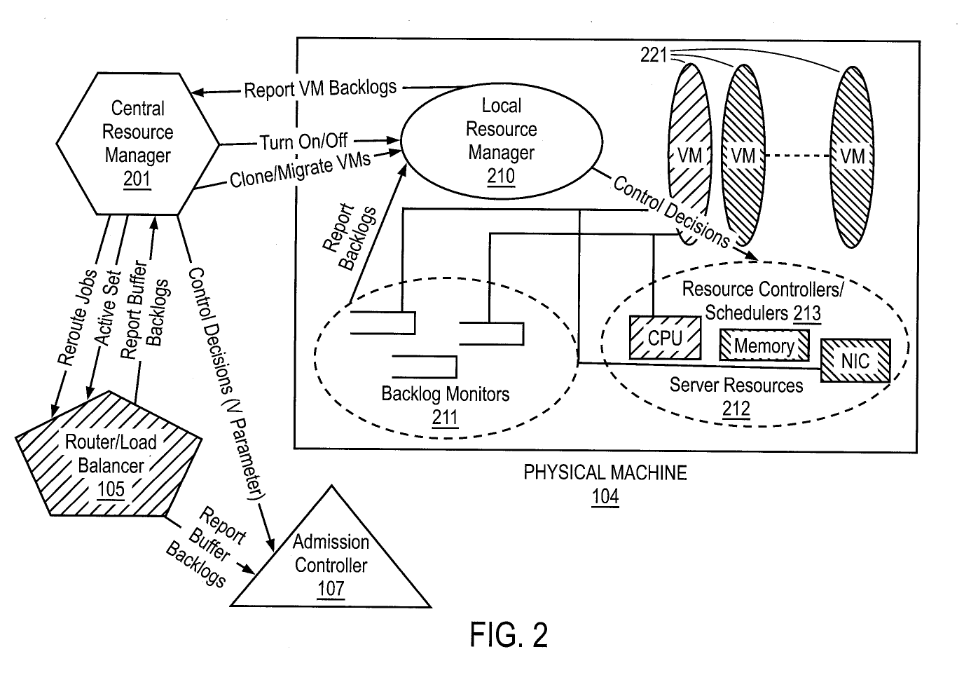

FIG. 2 is a block diagram depicting the role of each architectural component in one embodiment of the data center and signaling between components. Referring to FIG. 2, each server, such as physical machine 104, includes a local resource manager 210, one or more virtual machines (VMs) 221, resources 212 (e.g., CPU, memory, network bandwidth (e.g., NIC)), resources controllers/schedulers 213, and backlog monitoring modules 211. The remainder of the architectural components includes admission controller 101, router/load balancer 105, and central resource manager/entity 201.

In one embodiment, router 105 reports buffer backlogs of the data center buffer to both central resource manager 201 and admission controller 101. Admission controller 101 also receives control decisions, along with at least one system parameter (e.g., V) and, in response to these inputs, performs admission control. Router 105 performs routing of jobs from routing buffer 102 based on inputs from central resource manager 201, including indications of which jobs to reroute and which servers is in the active set (i.e., which servers are active).

Central resource manager 201 interfaces with the servers. In one embodiment, central resource manager 201 receives reports of VM backlogs from local resource manager 210 of each of servers 104 and sends indications to servers 104 of whether they are to be turned off or on. In one embodiment, central resource manager 201 only decides on which of servers 104 should be on/active. This decision depends on the backlogs reported by the backlog monitors for each virtual machine as well as the router buffers. Once the decision as to which servers are active is done, central resource manager 201 turns on or off servers of servers 104 according to the optimum configuration decision and informs router 105 about the new configuration so that the jobs are routed only to the active physical servers (i.e., the virtual machines (VMs) running on the active physical servers). Once this optimum configuration is set, the router 109 and local managers 210 can locally decide what to do independently from each other (i.e., decoupled from each other).

Central resource manager 201 determines whether jobs for a VM need to be rerouted and notifies router 105 if that is the case. This may occur, for example, if a VM is to be turned off. This also may occur where central resource manager 201 determines the optimum configuration of the data center and determines that one or more VMs and/or servers are no longer necessary or are additionally needed. In one embodiment, central resource manager 201 also sends indicates of whether to clone and/or migrate VMs to each of servers 104.

Local resource manager 210 is responsible for allocating local resources 212 to each VM in its server. This is accomplished by local resource manager 210 checking the backlog of each VM and making control decisions indicating which VM should receive which resources. Local resource manager 210 sends these control decisions to resource controllers 213 that control resources 212. In one embodiment, local resource controller 210 resides on the host operating system (OS) of each virtualized server. Backlog monitoring modules 211 monitor backlog for each of VMs 221 and report the backlogs to local resource manager 210, which forwards the information to central resource manager 201. In one embodiment, there is a backlog monitoring unit for each of the VMs. In another embodiment, there is a backlog monitoring module per VM per resource. Functions of one embodiment of the backlog monitors will be described using a specific example. If there are two VMs, VM1 and VM2, running on the same physical server and the CPU and network bandwidth are being monitored, then there will be two backlog monitors per VM, one to monitor CPU backlog and the other to monitor network backlog. For CPU backlog, the monitor for VM1 has to estimate what was the CPU demand of VM1 in a given time period and what was the CPU allocation for VM1 in the same period. If the demand—allocation <0, the backlog decreases. If demand—allocation >0, the backlog increases in that time period. Similarly, the monitor for VM1 has to estimate how many packets received for VM1 and how many are passed to VM1 in each time epoch to build a backlog queue. These monitors are running outside VMs, at the hypervisor level or at the host OS. These backlogs of different resources can be weighted or scaled differently to match the units.

More specifically, for every slot, for each application iεA, an admission controller 101 determines whether to admit or decline the new jobs (e.g., requests). The requests that are admitted are stored in a router buffer 102 before being routed to one of the servers 104 hosting that application by the router 105. Each of servers 104 in jεS has a set of resources Wⱼ (such as, for example, but not limited to, CPU, disk, memory, network resources, etc.) that are allocated to the applications hosted on it according to a resource controller. The control options available to the resource controller are discussed in detail below. In the remainder of the description, it is assumed that the sets Wⱼ contain only one resource, but it should be noted that multiple resources may be allocated, particularly since the extensions to multiple resources such as network bandwidth and memory are trivial. Specifically, the focus is on cases where the CPU is the bottleneck resource. This can happen, for example, when all the applications running on the servers are computationally intensive. The CPUs in the data center can be operated at different speeds by modulating the power allocated to them. This relationship is described by a power-speed curve which is known to the network controller, and well-known in the art. Note that this can be modeled using one of a number of existing models in a manner well-known in the art. Note also that the data for each physical machine can be obtained by offline measurements and/or using data sheets provided by the manufacturers.

In one embodiment, all servers in the data center are resource constrained. Specifically, below the focus is on power constraints. Modern CPUs can be operated at different speeds at runtime using techniques which are well-known in the art and discussed in more detail below. In one embodiment, the CPU is assumed to follow a non-linear power-frequency relationship that is known to the local resource controllers. The CPUs can run at a finite number of operating frequencies in an interval [fₘᵢₙ, fₘₐₓ] with an associated power consumption [Pₘᵢₙ, Pₘₐₓ]. This allows a tradeoff between performance and power costs. In one embodiment, all servers in the data center have identical CPU resources and can be controlled in the same way.

In order to save on energy costs, the servers may be operated in an inactive mode (power saving (e.g., P-states), stand by, OFF, or CPU hybernation) if the current workload is low. Similarly, inactive servers maybe turned active potentially to handle an increase in workload. An inactive server cannot provide any service to the applications hosted on it. Further, in one embodiment, in any slot, new requests can only be routed to active servers.

Since turning servers ON/OFF frequently may be undesirable in some embodiments (for example, due to hardware reliability issues), the focus below will be on the class on frame-based control policies in which time is divided into frames of length T slots. In one embodiment, the set of active servers is chosen at the beginning of each frame and is held fixed for the duration of that frame. This set can potentially change in the next frame as workloads change. Note that while this control decision is taken at a slower time-scale, the other resource allocations decisions (such as admission control, routing and resource allocations at each active server) are made every slot.

Let Aᵢ(t) denote the number of new requests for application i in slot t. In other words, Aᵢ(t) denotes an arrival rate. Let Rᵢ(t) be the number of requests out of Aᵢ(t) that are admitted into router buffer 102 for application i by admission controller 101. This buffer is denoted by Wᵢ(t) and is indicative of the backlog in the routing buffer for that application. Any new request that is not admitted by admission controller 101 is declined so that for all i, t, the following constraint is applied:

0≦Rᵢ(t)≦Aᵢ(t) (1)

which can easily be generalized to the case where arrivals that are not immediately accepted are stored in a buffer for future admission decision.

Let Rᵢⱼ(t) be the number of requests for application i that are routed from router buffer 102 to server j in slot t. Then the queueing dynamics for Wᵢ(t) is given by:

$${W}_{i} ( t + 1 ) = {W}_{i} ( t ) - {\sum }_{j} {R}_{ij} ( t ) + {R}_{i} ( t ) \qquad ( 2 )$$

Wᵢ(t) is the job queue maintained at the router, and Wᵢ(t) is the current backlog in the router queue for application i.

Let S(t) denote the set of active servers in slot t. For each application i, the admitted requests can only be routed to those servers that host application i and are active in slot t. Thus, the routing decisions Rᵢⱼ(t) satisfies the following constraint in every slot:

$$0 \leq {\sum }_{j ∈ 𝒮 ( t )} {a}_{ij} {R}_{ij} ( t ) \leq {W}_{i} ( t ) \qquad ( 3 )$$

For every slot, the resource controller in each server allocates the resources of each server among the virtual machines (VMs) that host the applications running on that server. In one embodiment, this allocation is subject to the available control options. For example, the resource controller in each server may allocate different fractions of the CPU (or different number of cores in case of multi-core processors) to the virtual machines in that slot. This resource controller may also use techniques such as dynamic frequency scaling (DFS), dynamic voltage scaling (DVS), or dynamic voltage and frequency scaling (DVFS) to modulate the CPU speed by varying the power allocation. The letters Ij are used to denote the set of all such control options available at server j. This includes the option of making server j inactive so that no power is consumed. Let Iᵢ(t)εIⱼ denote the particular control decision taken in slot t under any policy at server j and let Pᵢ(t) be the corresponding power allocation. Then, the queuing dynamics for the requests of application i at server j is given by:

Uᵢⱼ(t+1)=max[Uᵢⱼ(t)−μᵢⱼ(Iⱼ(t)),0]Rᵢⱼ(t) (4)

where μᵢⱼ(Iⱼ(t) denotes the service rate (in units of requests per slot) provided to application i on server j in slot t by taking control action Iᵢ(t). The expected value of service rate as a function of the resource allocation is known through off-line application profiling or online learning.

Thus, at every slot t, a control policy causes the following decisions to be made:
1) If t=nT (i.e., beginning of a new frame), determine the new set of active servers S(t); else, continue using the active set already computed for the current frame. In one embodiment, the determination is made by central resource manager 201.
2) Admission control decisions Rᵢ(t) for all applications i. In one embodiment, this is performed by admission controller 101.
3) Routing decisions Rᵢⱼ(t) for the admitted requests. In one embodiment, this is performed by router 105.
4) Resource allocation decision Iⱼ(t) at each active server (this includes power allocation Pⱼ(t) and resource distribution). In one embodiment, this is performed by local resource manager 210.

In one embodiment, the online control policy maximizes a joint utility of the sum throughput of the applications and the energy costs of the servers subject to the available control options and structural constraints imposed by this model. It is desirable to use a flexible and robust resource allocation algorithm that automatically adapts to time-varying workloads. In one embodiment, the technique of Lyapunov optimization is used to design such an algorithm. This technique allows for establishing analytical performance guarantees of this algorithm. Further, in one embodiment, any explicit modeling of the work load is not required and prediction based resource provisioning is not used.

### An Example of a Control Objective

Consider any policy η for this model that takes control decisions

S^{η}(t),Rᵢ^{η}(t),Rᵢⱼ^{η}(t),Iⱼ^{η}(t)ε [symbol] Pⱼ^{η}(t)

for all i,j in slot t. Under any feasible policy η, these control decisions satisfy the admission control constraint (1), routing constraint (3), and the resource allocation constraint Iⱼ(t)ε [symbol] every slot for all i,j.

Let rᵢ^{η} denote the time average expected rate of admitted requests for application i under policy η, i.e.,

$${r}_{i}^{n} = {lim}_{t \to ∞} \frac{1}{t} {\sum }_{τ = 0}^{t - 1} 𝔼 \{ {R}_{i}^{η} ( τ ) \} \qquad ( 5 )$$

Let r=(r₁, . . . , r_{N}) denote the vector of these time average rates. Similarly, let eⱼ^{η} denote the time average expected power consumption of server j under policy η:

$${e}_{j}^{η} {=}^{△} {lim}_{t \to ∞} \frac{1}{t} {\sum }_{τ = 0}^{t - 1} 𝔼 \{ {P}_{j}^{η} ( τ ) \} \qquad ( 6 )$$

The expectations above are with respect to the possibly randomized control actions that policy η might take.

Let αᵢ and β be a collection of non-negative weights, where αᵢ represents a priority associated with an application and β represents the priority of energy cost. Then the objective in one embodiment is to design a policy η that solves the following stochastic optimization problem:

$$Maximize \text{:} {\sum }_{i ∈ 𝒜} {α}_{i} {r}_{i}^{η} - β {\sum }_{j ∈ 𝒮} {e}_{j}^{η} \\ Subject to \text{:} 0 \leq {r}_{i}^{η} \leq {λ}_{i} ∀ i ∈ 𝒜 \\ {I}_{j}^{η} ( t ) ∈ {ℐ}_{j} ∀ j ∈ 𝒮 , ∀ t \\ r ∈ Λ \qquad ( 7 )$$

where Λ represents the capacity region of the data center model as described above. It is defined as the set of all possible long term throughput values that can be achieved under any feasible resource allocation strategy. In one embodiment, αᵢ and β are set by the data center operator, where αᵢ measures the monetary value per delivered throughput in an hour and β measures the monetary cost per kilowatt-hour (kWhr). In one embodiment, tthey are set to 1, meaning that per VM compute-hour cost is taken the same as per VM kWhr.

The objective in problem (7) is a general weighted linear combination of the sum throughput of the applications and the average power usage in the data center. This formulation allows for considering several scenarios. Specifically, it allows the design of policies that are adaptive to time-varying workloads. For example, if the current workload is inside the instantaneous capacity region, then this objective encourages scaling down the instantaneous capacity (by turning some servers inactive) to achieve energy savings. Similarly, if the current workload is outside the instantaneous capacity region, then this objective encourages scaling up the instantaneous capacity (by turning some servers active and/or running CPUs at faster speeds). Finally, if the workload is so high that it cannot be supported by using all available resources, this objective allows prioritization among different applications. Also this objective allows assigning priorities to different applications as well as between throughput and energy by choosing appropriate values of αᵢ and β.

Suppose (7) is feasible and let and for all i, j denote the optimal value of the objective function, potentially achieved by some arbitrary policy. It is sufficient to consider only the class of stationary, randomized policies that take control decisions independent of the current queue backlog every slot. However, computing the optimal stationary, randomized policy explicitly can be challenging and often impractical as it requires knowledge of all system parameters (like workload statistics) as well as the capacity region in advance. Even if this policy can be computed for a given workload, it would not be adaptive to unpredictable changes in the workload and must be recomputed. Next, an online control algorithm that overcomes all of these challenges is disclosed.

### An Embodiment of an Optimal Control Algorithm

In one embodiment, the framework of Lyapunov Optimization is used to develop an optimal control algorithm for the model. Specifically, a dynamic control algorithm can be shown to achieve the optimal solution and for all i, j to the stochastic optimization problem (7). The following collection [symbol] of subsets of S is defined:

[symbol]

{0, {1}, {1, 2}, {1, 2, 3}, . . . , {1, 2, 3, . . . , M}}

The control algorithm that is presented next will choose active server sets from this collection at the beginning of every T-slot frame.

### An Example of a Data Center Control Algorithm (DCA)

Let V≧0 be an input control parameter. This parameter is input to the algorithm and allows a utility-delay trade-off. In one embodiment, V parameter is set by the data center operator.

Let Wᵢ(t), Uᵢⱼ(t) for all i, j be the queue backlog values in slot t. In one embodiment, these are initialized to 0.

For every slot, the DCA algorithm uses the backlog values in that slot to make joint admission control, routing and resource allocation decisions. As the backlog values evolve over time according to the dynamics (2) and (4), the control decisions made by DCA adapt to these changes. However, in one embodiment, this is implemented using knowledge of current backlog values only and does not rely on knowledge of future/statistics of arrivals etc. Thus, DCA solves for the objective in (7) by implementing a sequence of optimization problems over time. The queue backlogs themselves can be viewed as dynamic Lagrange multipliers that enable stochastic optimization in a manner well-known in the art.

In one embodiment, the DCA algorithm operates as follows.

Admission Control: For each application i, choose the number of new requests to admit Rᵢ(t) as the solution to the following problem:

Maximize: Rᵢ(t)[Vαᵢ−Wᵢ(t)]

Subject to: 0≦Rᵢ(t)≦Aᵢ(t)

This problem has a simple threshold-based solution. In particular, if the current router buffer backlog for application i, Wᵢ(t)>V·αᵢ, then Rᵢ(t)=0 and no new requests are admitted. Otherwise, if Wᵢ(t)≦V·αᵢ, then Rᵢ(t)=Aᵢ(t) and all new requests are admitted. In one embodiment, this admission control decision can be performed separately for each application. Also, in another embodiment, admission control can be based on minimizing the quantity above where positions of Wᵢ(t) and V·αᵢ in the equation are reversed.

Routing and Resource Allocation: Let S(t) be the active server set for the current frame. In one embodiment, if t≠n·T, then the same active set of servers is continued to be used. The routing and resource allocation decisions are given as follows:

Routing: Given an active server set, routing follows a simple Join the Shortest Queue policy. Specifically, for any application i, let j′εS(t) be the active server with the smallest queue backlog U_{ij′}(t). If Wᵢ(t)>U_{ij′}(t), then R_{ij′}(t)=Wᵢ(t), i.e., all requests in router buffer 102 for application i are routed to server j′. Otherwise, Rᵢⱼ(t)=0 for all j and no requests are routed to any server for application i. In order to make these decisions, router 105 requires queue backlog information. Note that this routing decision can be performed separately for each application.

Resource Allocation: At each active server jεS(t), the local resource manager chooses a resource allocation Iⱼ(t) that solves the following problem:

$$Maximize \text{:} {\sum }_{i} {U}_{ij} ( t ) 𝔼 \{ {μ}_{ij} ( {I}_{j} ( t ) ) \} - V β {P}_{j} ( t )$$

$$Subject to \text{:} {I}_{j} ( t ) ∈ {ℐ}_{j} , {P}_{j} ( t ) \geq {P}_{min}$$

where Uᵢⱼ is the backlog of application i on server j, μᵢⱼ is the processing speed of the particular queue, V is the system parameter, β is the priority and Pⱼ(t) is the power expenditure of the server j. Pₘᵢₙ is this physical server's minimum power expenditure when it is on, but sitting idle. It can be measured per physical machine.

The above problem is a generalized max-weight problem where the service rate provided to any application is weighted by its current queue backlog. Thus, the optimal solution would allocate resources so as to maximize the service rate of the most backlogged application.

The complexity of this problem depends on the size of the control options [symbol] available at server j. In practice, the number of control options such as available DVFS states, CPU shares etc. is small/finite and thus, the above optimization can be implemented in real time. In one embodiment, each server (e.g., the local resource manager) solves its own resource allocation problem independently using the queue backlog values of applications hosted on it and this can be implemented in a fully distributed fashion.

In one embodiment, if t=n·T, then a new active set S*(t) for the current frame is determined by solving the following:

$${𝒮}^{*} ( t ) = {arg max}_{𝒮 ( t ) ∈ 𝒪} [ \begin{matrix}{\sum }_{ij} {U}_{ij} ( t ) 𝔼 \{ {μ}_{ij} ( {I}_{j} ( t ) ) \} - \\ V β {\sum }_{j} {P}_{j} ( t ) + {\sum }_{ij} {R}_{ij} ( t ) ( {W}_{i} ( t ) - {U}_{ij} ( t ) )\end{matrix} ]$$

$$subject to \text{:} j ∈ 𝒮 ( t ) , {I}_{j} ( t ) ∈ {ℐ}_{j} , {P}_{j} ( t ) \geq {P}_{min}$$

$$and constraints ( 1 ) , ( 3 ) .$$

The above optimization can be understood as follows. To determine the optimal active set S*(t), the algorithm computes the optimal cost for the expression within the brackets for every possible active server set in the collection [symbol] . Given an active set, the above maximization is separable into routing decisions for each application and resource allocation decisions at each active server. This computation is easily performed using the procedure described above for routing and resource allocation when t≠nT. Since [symbol] has size M, the worst-case complexity of this step is polynomial in M. However, the computation can be significantly simplified as follows. It can be shown that if max queue backlog on any server j>Uₜₕᵣₑₛₕ, then that server would be part of the active set for sure. Thus, only those subsets of [symbol] that contain these servers need to be considered.

When some of the active machines must be turned off since they are no longer in the active set, the application jobs queued at those machines can be (i) frozen and served later when the server is back up again, (ii) rerouted to one of the VMs of the same application using the load balancer/router, (iii) moved to other physical machines by VM migration (hence more than one VM on the same physical machine can be serving the same application), (iv) discarded by relying on the application layer to handle job losses. When the optimization stage decides to activate more servers at the end of a T-slot frame, the load balancer is informed about such a decision so that jobs waiting at the load balancer queues can be routed to these new locations. This potentially triggers a cloning operation for an application VM to be instantiated in the new location (if there is no such VM waiting in the dormant mode already).

### An Example of a Computer System

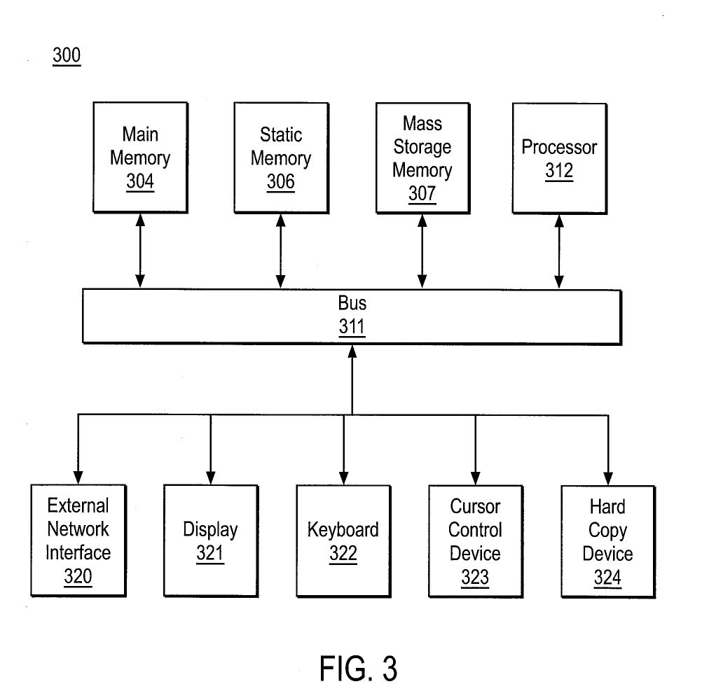

FIG. 3 is a block diagram of an exemplary computer system that may perform one or more of the operations described herein. Referring to FIG. 3, computer system 300 may comprise an exemplary client or server computer system. Computer system 300 comprises a communication mechanism or bus 311 for communicating information, and a processor 312 coupled with bus 311 for processing information. Processor 312 includes a microprocessor, but is not limited to a microprocessor, such as, for example, Pentium™, PowerPC™, Alpha™, etc.

System 300 further comprises a random access memory (RAM), or other dynamic storage device 304 (referred to as main memory) coupled to bus 311 for storing information and instructions to be executed by processor 312. Main memory 304 also may be used for storing temporary variables or other intermediate information during execution of instructions by processor 312.

Computer system 300 also comprises a read only memory (ROM) and/or other static storage device 306 coupled to bus 311 for storing static information and instructions for processor 312, and a data storage device 307, such as a magnetic disk or optical disk and its corresponding disk drive. Data storage device 307 is coupled to bus 311 for storing information and instructions.

Computer system 300 may further be coupled to a display device 321, such as a cathode ray tube (CRT) or liquid crystal display (LCD), coupled to bus 311 for displaying information to a computer user. An alphanumeric input device 322, including alphanumeric and other keys, may also be coupled to bus 311 for communicating information and command selections to processor 312. An additional user input device is cursor control 323, such as a mouse, trackball, trackpad, stylus, or cursor direction keys, coupled to bus 311 for communicating direction information and command selections to processor 312, and for controlling cursor movement on display 321.

Another device that may be coupled to bus 311 is hard copy device 324, which may be used for marking information on a medium such as paper, film, or similar types of media. Another device that may be coupled to bus 311 is a wired/wireless communication capability 325 to communication to a phone or handheld palm device.

Note that any or all of the components of system 300 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A virtualized data center architecture comprising:
a buffer to receive a plurality of requests from a plurality of applications;
a plurality of physical servers, wherein each server of the plurality of servers comprises
one or more server resources allocable to one or more virtual machines on said each server, wherein each virtual machine handles requests for a different one of a plurality of applications, and
local resource managers each running on said each server to generate resource allocation decisions to allocate the one or more resources to the one or more virtual machines running on said each server;
a router communicably coupled to the plurality of servers to control routing of each of the plurality of requests to an individual server in the plurality of servers;
an admission controller to determine whether to admit the plurality of requests into the buffer,
a central resource manager to determine which server of the plurality of servers are active, wherein decisions of the central resource manager depends on backlog information per application at each of the plurality of servers and the router, and further
wherein decisions regarding admission control made by the admission controller, decisions made regarding resource allocation made locally by each local resource manager in each of the plurality of servers, and decisions regarding routing of requests for an application between multiple servers by the router are decoupled from each other.

2. The virtualized data center defined in claim 1 wherein decisions regarding admission control made by the admission controller, decisions made regarding resource allocation made locally by each of the plurality of servers, and decisions regarding routing of requests for an application between multiple servers are decoupled from each other.

3. The virtualized data center defined in claim 1 wherein the admission controller chooses a number of requests to admit for each application based on a number of packets being received for the application, the backlog for the application in the admission controller, a system parameter, and priority of the application.

4. The virtualized data center defined in claim 3 wherein the system parameter is set by a central resource manager.

5. The virtualized data center defined in claim 3 wherein the admission controller chooses the number of requests to admit for each application based on a product of the number of packets being received for the application and a quantity equal to the backlog for the application in the admission controller less a product of the system parameter and the priority of the application.

6. The virtualized data center defined in claim 5 wherein the admission controller chooses the number of requests to admit for each application based on minimizing a product of the number of packets being received for the application and a quantity equal to the backlog for the application in the admission controller less a product of the system parameter and the priority of the application.

7. The virtualized data center defined in claim 6 wherein the admission controller admits all new requests as long as the backlog for the application in the admission controller is less than or equal to the product of the system parameter and the priority of the application and does not admit the new requests when the backlog for the application in the admission controller is greater than the product of the system parameter and the priority of the application.

8. The virtualized data center defined in claim 1 wherein the router makes a routing decision for one of the request for an application based on which virtual machine that supports the application has the shortest backlog of requests to handle.

9. The virtualized data center defined in claim 1 wherein the local resource manager chooses a resource allocation based on the backlog of the application on the server, the processing speed associated with the queue storing requests for the application, a system parameter, application priority and the power expenditure associated with the application.

10. The virtualized data center defined in claim 9 wherein the local resource manager chooses the resource allocation based on a sum of a product of the backlogs of each application of the plurality of applications on the server and the processing speed of the queue storing the backlog of the application on the server less a sum of products of the system parameter, the application priority and the power expenditure associated with the application.

11. The virtualized data center defined in claim 10 wherein the local resource manager chooses the resource allocation based on maximizing the sum of a product of the backlogs of each application of the plurality of applications on the server and the processing speed of the queue storing the backlog of the application on the server less the sum of products of the system parameter, the application priority and the power expenditure associated with the application.

12. The virtualized data center defined in claim 1 wherein the admission controller operates in response to control decisions and the system parameter from the central resource manager and in response to reported buffer backlogs of queues on each server for each of the plurality of applications.

13. The virtualized data center defined in claim 1 wherein the central resource manager is operable to send an indication to the router to reroute one or more application requests based on which of the plurality of servers are active.

14. The virtualized data center defined in claim 1 wherein the central resource manager is operable to determine which servers are to be active based on backlogs reported by virtual machine backlog monitors.

15. The virtualized data center defined in claim 13 wherein the router is operable to report, to the central resource manager, buffer backlogs of buffers that store application requests received by the data center.

16. The virtualized data center defined in claim 1 wherein said each server further comprises a plurality of queues, wherein each queue is associated with one virtual machine and stores requests for one of the plurality of applications.

17. The virtualized data center defined in claim 1 wherein said each server comprises one or more backlog monitors, each of the one or more backlog monitors monitors backlog for a resource for one of the one or more virtual machines.

18. The virtualized data center defined in claim 1 wherein the resources include one or more of CPU resources, memory resources and network bandwidth resources.

19. The virtualized data center defined in claim 1 wherein said each server further comprises one or more resource controllers that control the resource controllers, and further wherein the local resource manager sends control decisions to one or more resource controllers that control resource under control of the resource controllers.

20. A virtualized data center architecture comprising:
a buffer to receive a plurality of requests from a plurality of applications;
a plurality of servers, wherein each server of the plurality of servers comprises
one or more server resources allocable to one or more virtual machines on said each server, wherein each virtual machine handles requests for a different one of a plurality of applications, and
a local resource manager to generate resource allocation decisions to allocate the one or more resources to the one or more virtual machines;
a router communicably coupled to the plurality of servers to control routing of each of the plurality of requests to an individual server in the plurality of servers;
an admission controller to determine whether to admit the plurality of requests into the data center, wherein the admission controller chooses the number of requests to admit for each application based on minimizing a product of a number of packets being received for the application and a quantity equal to a backlog of requests for the application in the admission controller less a product of a system parameter and a priority of the application.

21. The virtualized data center defined in claim 21 wherein the admission controller admits all new requests as long as the backlog for the application in the admission controller is less than or equal to the product of the system parameter and the priority of the application and does not admit the new requests when the backlog for the application in the admission controller is greater than the product of the system parameter and the priority of the application.

22. The virtualized data center defined in claim 21 wherein the local resource manager chooses the resource allocation based on maximizing a sum of a product of the backlogs of each application of the plurality of applications on the server and processing speed of a queue storing the backlog of the application on the server less a sum of products of the system parameter, the application priority and a power expenditure associated with the application

23. A virtualized data center architecture comprising:
a buffer to receive a plurality of requests from a plurality of applications;
a plurality of servers, wherein each server of the plurality of servers comprises
one or more server resources allocable to one or more virtual machines on said each server, wherein each virtual machine handles requests for a different one of a plurality of applications, and
a local resource manager to generate resource allocation decisions to allocate the one or more resources to the one or more virtual machines, wherein the local resource manager chooses a resource allocation based on maximizing a sum of a product of backlogs of each application of the plurality of applications on the server and processing speed of a queue storing the backlog of the application on the server less a sum of products of the system parameter, the application priority and a power expenditure associated with the application;
a router communicably coupled to the plurality of servers to control routing of each of the plurality of requests to an individual server in the plurality of servers;
an admission controller to determine whether to admit the plurality of requests into the data center.

24. A method comprising:
receiving a plurality of requests from a plurality of applications;
allocating one or more server resources allocable to one or more virtual machines on each of a plurality of physical servers, including each virtual machine handling requests for a different one of a plurality of applications, and
local resource managers running on said each server to generate resource allocation decisions to allocate the one or more resources to the one or more virtual machines running on said each server;
controlling routing of each of the plurality of requests to an individual server in the plurality of servers;
an admission controller determining whether to admit the plurality of requests into the buffer,
a central resource manager determining which server of the plurality of servers are active, wherein decisions of the central resource manager depends on backlog information per application at each of the plurality of servers and the router, and further wherein decisions regarding admission control made by the admission controller, decisions made regarding resource allocation made locally by each local resource manager in each of the plurality of servers, and decisions regarding routing of requests for an application between multiple servers by the router are decoupled from each other.

25. The method defined in claim 24 further comprising the admission controller choosing a number of requests to admit for each application based on a number of packets being received for the application, the backlog for the application in the admission controller, a system parameter, and priority of the application.

26. The method defined in claim 24 further comprising the admission controller choosing the number of requests to admit for each application based on a product of the number of packets being received for the application and a quantity equal to the backlog for the application in the admission controller less a product of the system parameter and the priority of the application.

27. The method defined in claim 24 further comprising the local resource manager choosing a resource allocation based on the backlog of the application on the server, the processing speed associated with the queue storing requests for the application, a system parameter, application priority and the power expenditure associated with the application.
